(19) United States
(12) Patent Application Publication
(10) Pub. No.: US 2010/0149698 A1
(43) Pub. Date: Jun. 17, 2010

(54) THERMAL PROTECTOR FOR ELECTRIC MOTORS, IN PARTICULAR FOR COMPRESSOR MOTORS

(75) Inventors: Carlo Torella, Milano (IT); Giovanni Barbieri, Milano (IT)

Correspondence Address: YOUNG & THOMPSON, 209 Madison Street, Suite 500, Alexandria, VA, 22314, US

(73) Assignee: ELECTRICA S.R.L., Milano (IT)

(21) Appl. No.: 12/634,973

(22) Filed: Dec. 10, 2009

(30) Foreign Application Priority Data
Dec. 12, 2008 (IT) MI2008A002211

(51) Int. Cl. H02H 7/08

(52) U.S. Cl. 361/30

(57) ABSTRACT

Thermal protector for electric motors, includes:
a body which supports all the components of the device,
a switch having a fixed part and a mobile part,
an element made of bimetallic material, inserted between the mobile part and heating elements designed to heat the bimetallic element, and control the movement of the mobile part away from fixed part,
terminals which connect the device to the mains power supply,
a terminal which connects the device to the motor power supply connector,
wherein the elements include a spiral resistor wound about a straight axis, through which the current supplying the motor passes. The resistor is housed in a seating made in the body, such that its axis is aligned with contact zones of the switch; the seating being cradle-shaped, with a section having a semicircular contour for housing the heating elements, and two smooth side walls, which slant divergently upwards.

This invention relates to a thermal protector for electric motors, in particular a protector for refrigerator compressor motors or the like, such as a protector which can be fitted to the “common” contact of the compressor's power connector to cut off the mains current to the motor windings in the event of power surges or spikes, in order to protect the motor against breakdowns or malfunctions.

In detail, the invention relates to a thermal protector substantially consisting of a normally-closed switch comprising a first fixed contact mounted on the body of the device, a second mobile contact positioned at the end of a flexible plate constrained at one end to said body of the device, and a bimetallic component which, if activated, moves the plate from the active position where it comes into contact with the fixed part, allowing current to pass to the motor windings, to a non-operational position where said plate is distanced from the fixed contact and interrupts the passage of current to the motor.

According to the invention, the movement of the mobile contact of the plate takes place via a bimetallic component in the lower part of said plate, which undergoes a temperature increase due to a resistive heating element, installed under the plate, through which current passes, which said heating element, due to the Joule effect, produces a quantity of thermal power proportional to the square of the current.

When the current exceeds a certain value, the heat produced by the resistor heats the bimetallic strip, causing a variation in its curvature, and this movement acts directly on the plate, causing the mobile contact to open and consequently interrupting the passage of current.

A characteristic feature of the invention is that said heating element consists of a spiral resistor, wound about a straight axis and positioned in a seating made in the body of the device, which lies along an axis parallel to the plate and therefore to the mobile contact. This characteristic allows the magnetic field generated by the passage of current through the coil to be exploited; said magnetic field is directed along the coil axis, and generates a magnetic blow-out that more efficiently interrupts the electrical arc created when the two contacts of the switch separate, in order to guarantee that the device is more durable and reliable.

Said seating made in the body of the device, which is designed to house the resistor, is shaped, according to the invention, so that the heat generated by the heating element is optimally directed towards the bimetallic component above. In this way, the heat irradiated to the bimetal being equal, the length of the coil can be significantly reduced, leading to savings in terms of the materials used and the passive consumption of the device.

Various types of device designed to protect motors and other electrical equipment against voltage and current surges are present on the market.

In particular, thermal protectors comprising a switch controlled via a bimetallic element heated by a resistor or the like, through which the current that powers the motor passes, are already known and widely used.

For example, some known devices have a heating element consisting of a spiral resistor, made of a suitable material, wound in a circular direction and positioned under a bimetallic disc which, in turn, is placed under the mobile contact element of the switch.

When the current circulating in the motor exceeds a pre-determined value, for example due to a power supply problem or a malfunction of the motor that generates electrical absorption, the heating element dissipates a quantity of energy and converts it into heat, thus increasing the temperature of the bimetallic disc.

When the temperature reaches a pre-set calibration value said disc is deformed, curving so as to distance the moving contact of the switch from the fixed contact, and cutting off the power supply to the motor.

These devices according to the prior art, though fairly efficient, could be further improved to eliminate some minor drawbacks.

A first drawback relates to the reliability and durability of the switch, especially the two contact elements; the problem arise when, due to a malfunction or the like, both contacts open and a short but intense electrical arc is generated between them which, with time and the increased number of switch opening and closing cycles, can wear out said contacts to the point where the device becomes unusable.

Another aspect which could be improved relates to the passive energy consumption of these protective devices which, though constituting a relatively small percentage of the global consumption of the equipment to which they are fitted, is becoming a problem which has recently attracted considerable attention.

In particular, the shape of the heating element, which is usually fitted circumferentially around the perimeter of the bimetallic disc, requires the length of the spiral resistor to be compatible with the size of said disc.

Although this solution ensures uniform heating of the disc, it is not optimised in terms of heating efficiency in view of the ratio between the electricity dissipated and the heat transferred to the bimetallic disc.

To eliminate said problems of the prior art, this invention offers a thermal protector for electric motors, in particular a protector for the electric motors of refrigerator compressors or the like, of the type comprising a switch controlled via an element made of bimetallic material, and means designed to heat said element from a temperature range of correct operation, wherein it retains its original contour and allows the passage of current, to a higher temperature range at which its curvature varies and it actively operates on the mobile contact of the switch so as to cut off the power supply; moreover, said components designed to heat the bimetallic element consist of a spiral resistor, wound about a straight axis and positioned in a seating made in the body of the device, and lying along an axis parallel to the plate and therefore to the mobile contact. This configuration allows the magnetic field generated by the passage of current through the resistor to be exploited; said magnetic field is directed along the axis of the resistor, and generates a magnetic blow-out that more efficiently interrupts the electrical arc created when the two contacts of the switch separate, in order to prevent the problems described above.

According to the invention the seating in which the heating element is housed is cradle-shaped, with smooth, slanting side walls designed to direct the greatest possible quantity of heat generated by the heating element towards the bimetallic element above, thus reducing dispersion and optimising the size of the resistor.

This invention will now be described in detail, by way of example but not of limitation, by reference to the annexed figures wherein:

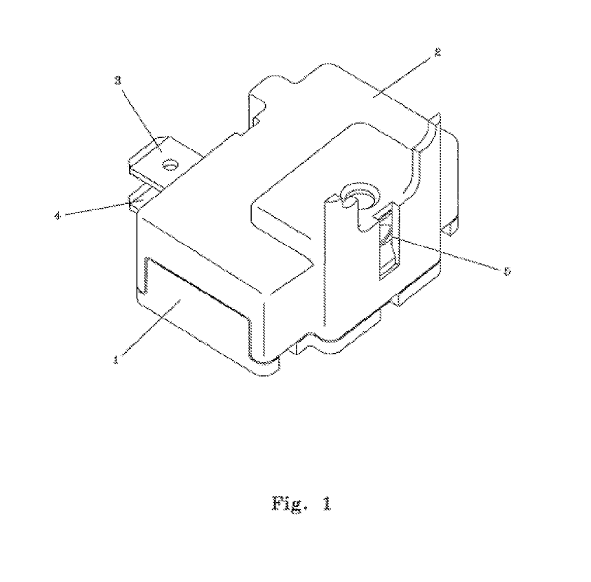

FIG. 1 is a perspective view of the assembled thermal protector according to the invention;

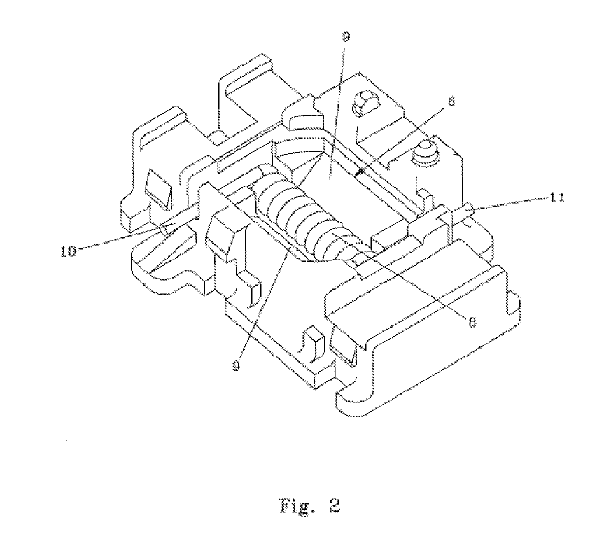

FIG. 2 is a perspective view of the body of the device with the heating element inserted in its seating, according to the invention;

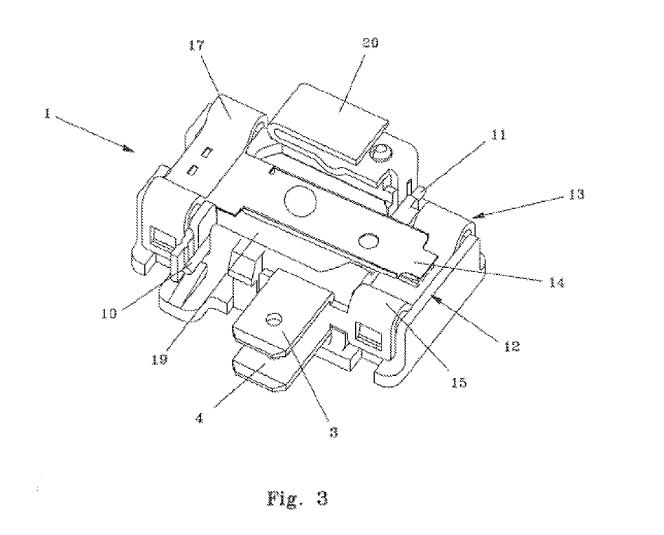

FIG. 3 is a perspective view of the thermal protector with all components but without the upper lid, according to the invention;

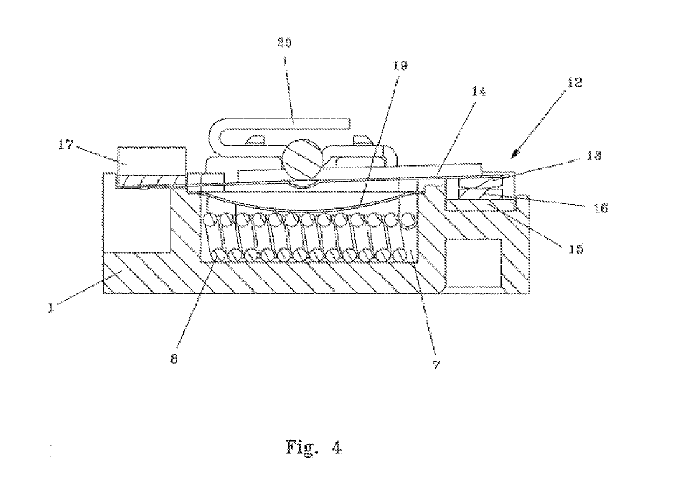

FIG. 4 is a cross-section of the thermal protector according to the invention;

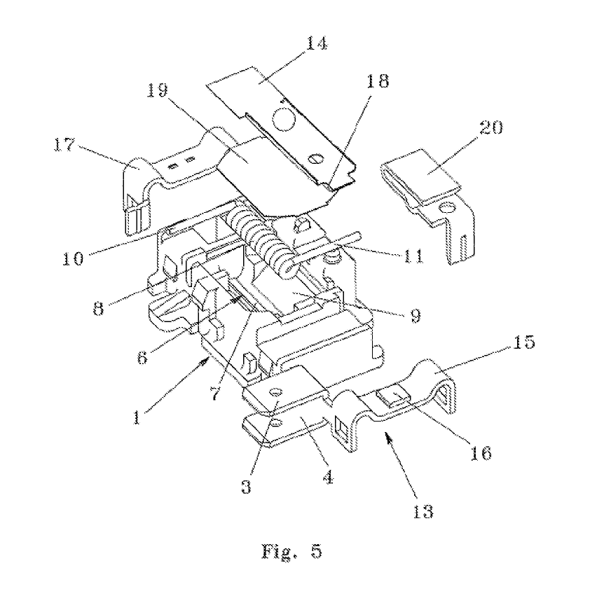

FIG. 5 is an exploded perspective view of the thermal protector according to the invention.

As shown in the annexed figures, the thermal protector for electric motors, in particular for the electric motors of refrigerator compressors or the like, comprises a body 1, which constitutes the support base to which all the components are fitted, closed at the top by a lid 2 in which an opening 5 is made for the insertion of the “common” pin of the motor power supply connector, not shown in the figure, and from which project two fastons 3 and 4, connected to the mains power supply. If necessary, the faston connections can be replaced to order by electrical cable connections.

Said body 1 consists of a substantially parallelepipedal element, preferably made of plastic polymers, on which there are a series of projections designed to form snap-on connections for securing the various terminals and upper lid 2.

In the central part of the body there is a cradle-shaped seating 6 comprising a first section 7 at the base of said seating which has a semicircular contour and houses heating element 8, and two side walls 9, adjacent to said element 8, which are smooth and slant divergently upwards.

Said heating element 8 consists of a spiral resistor wound about a straight axis; the two ends thereof, 10 and 11, are elongated so that they project from seating 6, and are designed to receive current from the mains and convey it to the compressor's power supply connector respectively.

Contact 12 of the device consists of a terminal 13, integral with body 1, to which the fixed contact of the switch is connected, and a mobile part, consisting of a flexible plate 14 constrained at one end to body 1 via terminal 17, to which the mobile contact is integrally attached.

In particular, the fixed contact of the switch consists of a metal terminal 13, which is attached to body 1 by snap-on means, and to which is attached contact 16, which constitutes the first contact element of the switch; terminal 13 is also integral with the two faston connectors 3 and 4, which are connected to the external mains power supply and can be replaced to order by electric cable connections if necessary.

Plate 14 is constrained at one end via terminal 17, also metallic, and attached to body 1 by snap-on means, while contact 18, which constitutes the mobile element of the switch, is attached to the opposite free end.

Said terminal 17 in turn is in contact with end 10 of heating element 8 to allow the passage of current from fastons 3 and 4.

A bimetallic element 19 is positioned at the upper opening in seating 6 of body 1, between heating element 8 and switch plate 14.

Terminal 20, designed to house the “common” pin of the motor power supply connector, not shown in the figure, is attached to body 1 by lid 2, and is in contact with end 11 of heating element 8 to allow the passage of current.

Current circulates in the device as follows:
it enters through fastons 3 and 4 of metal terminal 15
it passes through contacts 16 and 18 of the switch
it passes through plate 14 and metal terminal 17
it enters heating element 8 through end 10
it passes through heating element 8
it exits from heating element 8 through end 11
it passes via terminal 20 to the “common” pin of the motor power supply connector.

Under normal operating conditions, the current that circulates in heating element 8 generates a quantity of heat due to the Joule effect; said heat generated by the heating element heats bimetallic element 19 to a given pre-set calibration temperature.

Under these conditions, bimetallic element 19 substantially retains its original upward curvature, and does not interfere with plate 14 beneath.

When a power surge from the outside occurs, or high absorption by the motor due to a malfunction, the quantity of current circulating in the device increases, as does the quantity of heat generated by the heating element.

The greater amount of heat increases the temperature of bimetallic element 19, the curvature of which varies when the pre-set calibration value is exceeded; in particular it curves downwards, pushing plate 14 upwards, and thus separating the two contacts 16 and 18 and interrupting the passage of current.

Under these circumstances, as mentioned, the separation of the two contacts creates a short but very intense electrical arc, which in the long term causes wear on contacts 16 and 18.

The purpose of the invention is to limit the intensity of the electrical arc with the aid of the magnetic field created by the passage of current in heating element 8.

The straight design of the coil allows a magnetic field to be created and directed along the axis of the coil, perpendicular to the flow of current to contacts 16 and 18 (whence the description “magnetic blow-out”), which makes quenching of the electrical arc faster and less destructive.

Due to the shape of seating 6 in body 1, which houses heating element 8, the invention also allows the heat generated by said heating element to be directed optimally towards bimetallic element 19.

Due to their mirror surface and slant, walls 9 of the seating reflect the majority of heat upwards, to the point where bimetallic element 19 is located, thus minimising losses to the exterior.

In this way, the heat irradiated by the bimetallic element being equal, the length of the heating element can be significantly reduced, leading to savings in terms of the material used and the passive consumption of the device.

An expert in the field could devise various modifications and variations, all of which should be deemed to fall within the ambit of this invention.

1. Thermal protector for electric motors, in particular a protector for electric motors designed for refrigerator compressors and the like, comprising:
a body (1) which constitutes the support to which all the components of the device are attached
a switch (12) consisting of a fixed part (13) and a mobile part (14)
an element made of bimetallic material (19), inserted between the mobile part (14) of switch (12) and heating means (8), which are designed to control the movement of said mobile part (14) away from fixed part (13)
means (8) designed to heat said bimetallic element
terminals (3, 4) which connect the device to the mains power supply
a terminal (20) which connects the device to the motor power supply connector
characterised in that said means designed to heat the bimetallic element consist of a spiral resistor (8) wound along a straight axis, through which the current supplying the motor passes, which said resistor is housed in a seating (6) made in body (1) of the device, and positioned in such a way that its axis is aligned with the zone of contacts (13) and (14) of switch (12); said seating (6) being cradle-shaped, with a section (7), corresponding to the base of said seating (6), having a semicircular contour, in which heating element (8) is housed, and two smooth side walls (9), positioned alongside said heating element (8), which slant divergently upwards.

2. Thermal protector for electric motors, in particular a protector for electric motors designed for refrigerator compressors and the like, as claimed in claim 1, characterised in that said fixed part (13) of switch (12) consists of a metal terminal (15) to which is attached a contact (16) that constitutes the first element of said switch; which said terminal (15) is snap-fitted to body (1) of the device and is integral with two fast on terminals (3 and 4) designed to connect the protector to the mains power supply.

3. Thermal protector for electric motors, in particular a protector for electric motors designed for refrigerator compressors and the like, as claimed in claim 1, characterised in that said mobile part (14) of the switch consists of a metallic strip (14) constrained to one end of body (1), to the free end of which is attached a contact (18) that constitutes the second element of switch (12).

4. Thermal protector for electric motors, in particular a protector for electric motors designed for refrigerator compressors and the like, as claimed in claim 1, characterised in that said body (1) presents a set of projections, each of which forms a snap-on connection to secure the various terminals (3, 4, 15, 17) and upper lid (2).

5. Thermal protector for electric motors, in particular a protector for electric motors designed for refrigerator compressors and the like, as claimed in claim 1, characterised in that said contacts (3, 4, 15, 17 and 20) are made of steel.

6. Thermal protector for electric motors, in particular a protector for electric motors designed for refrigerator compressors and the like, as claimed in claim 1, characterised in that said resistor (8) has two ends (10 and 11) which project from seating (6) so as to contact terminal (17) and terminal (20) respectively.
